(19) United States
(12) Patent Application Publication
(10) Pub. No.: US 2023/0040634 A1
(43) Pub. Date: Feb. 9, 2023

(54) PREY PROTECTION FELINE COLLAR AND METHODS OF MANUFACTURING SAME

(71) Applicant: Crazy K Farm Pet and Poultry Products, LLC, Hempstead, TX (US)

(72) Inventor: Tobi Kosanke, Hempstead, TX (US)

(73) Assignee: Crazy K Farm Pet and Poultry Products, LLC, Hempstead, TX (US)

(21) Appl. No.: 17/817,188

(22) Filed: Aug. 3, 2022

Related U.S. Application Data
(60) Provisional application No. 63/229,934, filed on Aug. 5, 2021.

(51) Int. Cl. A01K 27/00

(52) U.S. Cl. CPC A01K 27/009; A01K 27/001

(57) ABSTRACT

A prey protection feline collar includes a collar body comprising a brim defining a planar internal area, inside and outside perimeters, a face side, and a cutout having edges, the inside and outside perimeters together defining a plane projecting substantially parallel to the planar internal area, the brim configured to extend outward from a surface of a neck of a feline responsive to being worn, a clasp removably connecting the edges to form a closure at the cutout, a light reflector disposed at the face side of the brim and, responsive to receiving light, reflecting the light away from the face side, and an audible warning device connected to the brim. The collar body includes a sleeve traversing the inside perimeter. A ribbon extends through the sleeve lumen and is connected to respective parts of the clasp.

### CROSS-REFERENCE TO RELATED APPLICATIONS

This application claims the priority, under 35 U.S.C. § 119, of copending U.S. Provisional Patent Application No. 63/229,934, filed Aug. 5, 2021; the prior application is herewith incorporated by reference herein in its entirety.

### STATEMENT REGARDING FEDERALLY SPONSORED RESEARCH OR DEVELOPMENT

Not Applicable

### FIELD OF THE INVENTION

The present systems, apparatuses, and methods lie in the field of cat accessories. The present disclosure relates to a collar for a feline to protect feline prey from being hurt and methods of manufacturing same.

### BACKGROUND OF THE INVENTION

Outdoor cats hunt small prey animals and hurt or kill them. Due to the large number of indoor/outdoor and outdoor felines, there exists a significant problem with the decline in all prey species hunted by felines. It would be beneficial to provide indoor/outdoor and outdoor-felines with a mechanism that alerts potential prey that the feline is present so that the prey can escape before the hunting feline is able to make contact with the prey. While it is common for such hunting felines to be wearing collars, such prior art collars do not alert the prey to the feline's presence. It is desirable to prevent the feline from successfully stalking and/or harming or killing its prey.

Thus, a need exists to overcome the problems with the prior art systems, designs, and processes as discussed above.

### SUMMARY OF THE INVENTION

The systems, apparatuses, and methods described provide a prey protection feline collar and methods of manufacturing same that overcome the hereinafore-mentioned disadvantages of the heretofore-known devices and methods of this general type and that provide such features while alerting prey to a cat's presence, thereby preventing the cat to successfully stalk and harm or kill the prey animal.

With the foregoing and other objects in view, there is provided, a prey protection feline collar comprising a collar body comprising a brim defining a planar internal area, an inside perimeter, an outside perimeter, a face side, and a cutout having edges, the inside and outside perimeters together defining a plane that projects substantially parallel to the planar internal area, the brim being configured to extend outward from a surface of a neck of a feline responsive to being worn, a clasp removably connecting the edges to form a closure at the cutout, a light reflector disposed at the face side of the brim and, responsive to receiving light, reflecting the light away from the face side, and an audible warning device connected to the brim.

With the foregoing and other objects in view, there is also provided, a prey protection feline collar comprising a collar body comprising a brim defining a planar internal area, an inside perimeter, an outside perimeter, a face side, and a cutout having edges, the inside and outside perimeters together defining a plane that projects substantially parallel to the planar internal area, the brim being configured to extend outward from a surface of a neck of a feline responsive to being worn and a sleeve traversing the inside perimeter and defining therein a lumen, a ribbon extending through the lumen around the inside perimeter and having opposing ribbon ends, a clasp disposed in the cutout and comprising a first lock part connected to one of the ribbon ends and a second lock part connected to the other one of the ribbon ends, the first and second lock parts being removably connected to one another to form a closure at the cutout, a light reflector disposed at the face side of the brim and, responsive to receiving light, reflecting the light away from the face side, and an audible warning device connected to the brim.

With the objects in view, the brim is substantially planar.

With the objects in view, the brim is in the form of a renaissance Elizabethan ruff collar neck ruffle.

In accordance with another feature, the brim comprises at least a portion having a prey-alerting color at the face side.

In accordance with a further feature, the prey-alerting color is at least one of white, yellow, orange, red, yellow-green having a wavelength curve peaking at 555 nanometers, a combination of any of the above colors, a pattern of any of the above colors, and a pattern of a combination of any of the above colors.

In accordance with an added feature, the inside perimeter is sized to fit a household feline.

In accordance with an additional feature, the light reflector is a light-reflective tape one of attached to and integral with the brim.

In accordance with yet another feature, the light reflector comprises reflective strips adjacent each of the edges of the cutout.

In accordance with yet a further feature, the audible warning device is at least one of a bell and an electronic tone generator.

In accordance with yet an added feature, the collar body comprises a sleeve traversing the inside perimeter and defining therein a lumen, and there is further provided a ribbon extending through the lumen around the inside perimeter and having opposing ribbon ends, the clasp comprising a first lock part connected to one of the ribbon ends and a second lock part connected to the other one of the ribbon ends, the first and second lock parts being removably connected to one another to form the closure at the cutout.

In accordance with yet an additional feature, the clasp has two portions that removably connect to one another.

In accordance with yet another feature, the two portions removably connect by at least one of hook-and-loops, hook and eye, lobster, toggle, spring, torpedo, box, fishhook, magnets, buckle and holes, and snap parts.

In accordance with a concomitant feature, the sleeve is a set of sleeve portions traversing the inside perimeter that, together, define therein a lumen and the ribbon extends through the lumen of the sleeve portions around the inside perimeter.

Although the systems, apparatuses, and methods are illustrated and described herein as embodied in a prey protection feline collar and methods of manufacturing same, it is, nevertheless, not intended to be limited to the details shown because various modifications and structural changes may be made therein without departing from the spirit of the invention and within the scope and range of equivalents of the claims. Additionally, well-known elements of exemplary embodiments will not be described in detail or will be omitted so as not to obscure the relevant details of the systems, apparatuses, and methods.

Additional advantages and other features characteristic of the systems, apparatuses, and methods will be set forth in the detailed description that follows and may be apparent from the detailed description or may be learned by practice of exemplary embodiments. Still other advantages of the systems, apparatuses, and methods may be realized by any of the instrumentalities, methods, or combinations particularly pointed out in the claims.

Other features that are considered as characteristic for the systems, apparatuses, and methods are set forth in the appended claims. As required, detailed embodiments of the systems, apparatuses, and methods are disclosed herein; however, it is to be understood that the disclosed embodiments are merely exemplary of the systems, apparatuses, and methods, which can be embodied in various forms. Therefore, specific structural and functional details disclosed herein are not to be interpreted as limiting, but merely as a basis for the claims and as a representative basis for teaching one of ordinary skill in the art to variously employ the systems, apparatuses, and methods in virtually any appropriately detailed structure. Further, the terms and phrases used herein are not intended to be limiting; but rather, to provide an understandable description of the systems, apparatuses, and methods. While the specification concludes with claims defining the systems, apparatuses, and methods of the invention that are regarded as novel, it is believed that the systems, apparatuses, and methods will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the systems, apparatuses, and methods. Advantages of embodiments of the systems, apparatuses, and methods will be apparent from the following detailed description of the exemplary embodiments thereof, which description should be considered in conjunction with the accompanying drawings in which:

FIG. 1 is a plan view of an exemplary embodiment of a prey protection feline collar in a clasped orientation;

FIG. 2 is a perspective side view of an exemplary embodiment of an Elizabethan prey protection feline collar;

FIG. 3 is a perspective top view of the Elizabethan prey protection feline collar of FIG. 2;

FIG. 4 is a plan view of the prey protection feline collar of FIG. 1 in an unclasped laid-out orientation; and

FIG. 5 is a plan view of an exemplary embodiment of an Elizabethan prey protection feline collar in a clasped orientation.

### DETAILED DESCRIPTION OF THE EMBODIMENTS

As required, detailed embodiments of the systems, apparatuses, and methods are disclosed herein; however, it is to be understood that the disclosed embodiments are merely exemplary of the systems, apparatuses, and methods, which can be embodied in various forms. Therefore, specific structural and functional details disclosed herein are not to be interpreted as limiting, but merely as a basis for the claims and as a representative basis for teaching one skilled in the art to variously employ the systems, apparatuses, and methods in virtually any appropriately detailed structure. Further, the terms and phrases used herein are not intended to be limiting; but rather, to provide an understandable description of the systems, apparatuses, and methods. While the specification concludes with claims defining the features of the systems, apparatuses, and methods that are regarded as novel, it is believed that the systems, apparatuses, and methods will be better understood from a consideration of the following description in conjunction with the drawing figures, in which like reference numerals are carried forward.

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Alternate embodiments may be devised without departing from the spirit or the scope of the invention. Additionally, well-known elements of exemplary embodiments of the systems, apparatuses, and methods will not be described in detail or will be omitted so as not to obscure the relevant details of the systems, apparatuses, and methods.

Before the systems, apparatuses, and methods are disclosed and described, it is to be understood that the terminology used herein is for the purpose of describing particular embodiments only and is not intended to be limiting. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. The terms “including” and/or “having,” as used herein, are defined as comprising (i.e., open language). The terms “a” or “an”, as used herein, are defined as one or more than one. The term “plurality,” as used herein, is defined as two or more than two. The term “another,” as used herein, is defined as at least a second or more. The description may use the terms “embodiment” or “embodiments,” which may each refer to one or more of the same or different embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact (e.g., directly coupled). However, “coupled” may also mean that two or more elements are not in direct contact with each other, but yet still cooperate or interact with each other (e.g., indirectly coupled).

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

Relational terms such as first and second, top and bottom, and the like may be used solely to distinguish one entity or action from another entity or action without necessarily requiring or implying any actual such relationship or order between such entities or actions. The description may use perspective-based descriptions such as up/down, back/front, top/bottom, and proximal/distal. Such descriptions are merely used to facilitate the discussion and are not intended to restrict the application of disclosed embodiments. Various operations may be described as multiple discrete operations in turn, in a manner that may be helpful in understanding embodiments; however, the order of description should not be construed to imply that these operations are order dependent.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

Herein various embodiments of the systems, apparatuses, and methods are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

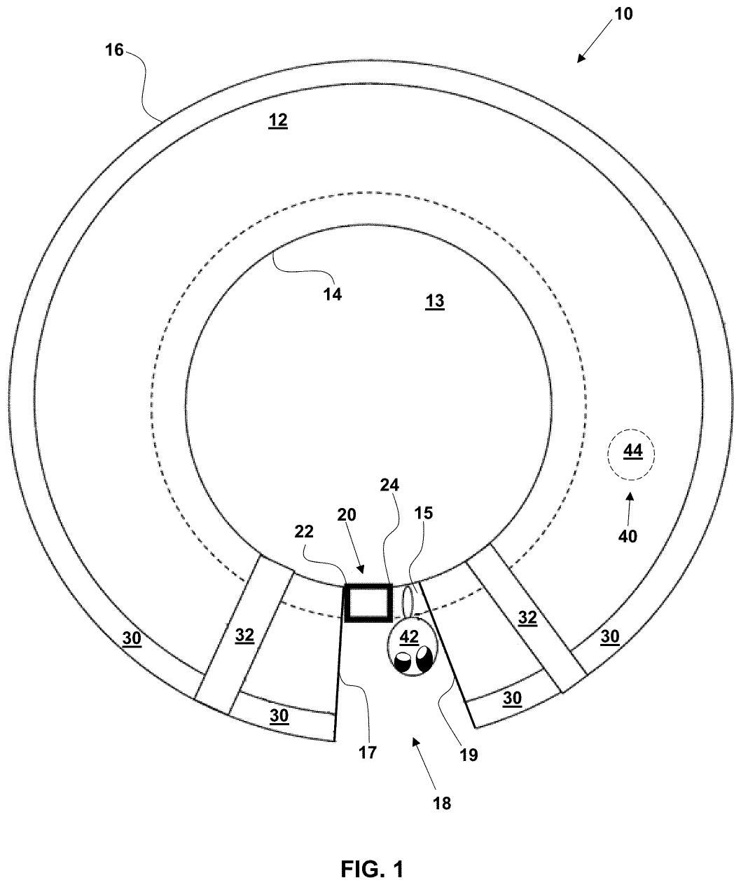

Described now are exemplary embodiments. Referring now to the figures of the drawings in detail and first, particularly to FIG. 1, there is shown a first exemplary embodiment of a prey protection feline collar 10. The collar 10 takes the form of an Elizabethan collar, in that it has a wide brim 12 that sticks out outward (e.g., orthogonally) from the wearer, the sticking-out direction leading from an inside perimeter 14 to an outside perimeter 16 to define a width of the brim 12. The inside perimeter 14 defines a substantially planar internal area 13. Accordingly, the inside and outside perimeters 14, 16 together define a plane that projects substantially parallel to the planar internal area 13, thereby allowing the brim 12 to extend outward from a surface of a neck of a feline responsive to being worn. As used herein, substantially parallel takes into account that the brim 10 can be of a material that is flexible, at least enough to be comfortable for the feline. Accordingly, it is likely that the inside perimeter 14 does not exactly lie in a plane and, therefore, opposing sides of the brim 10 do not lie in a perfect plane. As the material is flexible, the two opposing side may not be perfectly planar. However, when manufactured and laid flat on a table, the brim 12 can be made to be almost planar, thereby making the inside perimeter 14 to lie in a single plane and the outside perimeter 16 to lie in a single plane. This is what it means to have the inside and outside perimeters 14, 16 together define a plane that projects substantially parallel to the planar internal area 13. In an exemplary embodiment, the width is between approximately 1″ and approximately 4″, in particular, between approximately 1.5″ and approximately 3″ and, more particularly, between approximately 2.5″ to 2.75″. A portion of the outer brim 12 is not present when the brim 12 is shaped to enclose the internal area 13 within the inside perimeter 14. This portion forms a cutout 18 that allows the collar 10 to be adjusted to fit different sized feline necks.

To assist such modification, an adjustable and openable clasp 20 that serves two functions exists at the inside perimeter 14 of the cutout 18. First, the clasp 20 permits the two edges 17, 19 of the cutout 18 to move towards and away from one another. In an exemplary embodiment, a left half 22 of the clasp is detachable from a right half 24 of the clasp. Exemplary embodiments of the clasp include any of hook-and-loops, hook and eye clasps, lobster clasps, toggle clasps, spring clasps, torpedo clasps, box clasps, fishhook clasps, magnetic clasps, buckles and holes, pull-apart, and snaps.

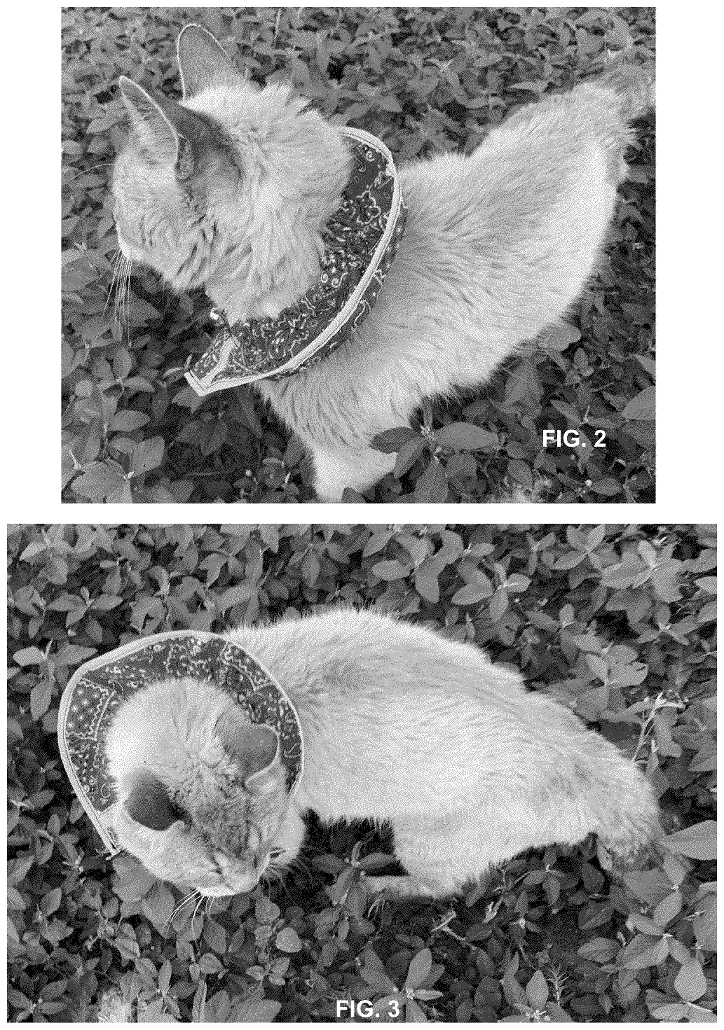

In this manner, holding the two parts 22, 24 of the clasp 20 in the user's hands allows the user to wrap the inside perimeter 14 around the neck of the feline on which the collar 10 is to be placed, the two edges where the user holds the parts defining the edges 17, 19 and the cutout 18. Then, when the two parts 22, 24 of the clasp 20 are connected together, the collar 10 is secured removably on the feline, as shown, for example, in FIGS. 2 and 3, thereby forming a closure at the cutout. Second, the clasp 20 also acts as a tightening mechanism to shorten or lengthen the inside perimeter 14, thereby tightening (closing) or loosening (opening) the collar 10 around the feline's neck. One exemplary embodiment for tightening the collar 10 is a ribbon 15 that extends from the cutout edge 19 to the clasp 20. As used herein, ribbon is used in a broad sense to refer to any shape of cord, cable, or string (flat or rounded) that can extend around the inside perimeter 14 and have a releasable securing device, e.g., a clasp, secure the two ends thereof as desired by a user of the collar 10. In this exemplary embodiment, the ribbon 15 inserts inside and through the clasp 20 to exit out either the back, the front, or the opposite side of the clasp 20 (not illustrated in FIG. 1). In this manner, pulling on the distal end of the ribbon 15 will cause the edge 19 to approach the edge 17 and, thereby, tighten the collar 10 about a feline's neck. An example of the ribbon 15 is a standard adjustable feline collar.

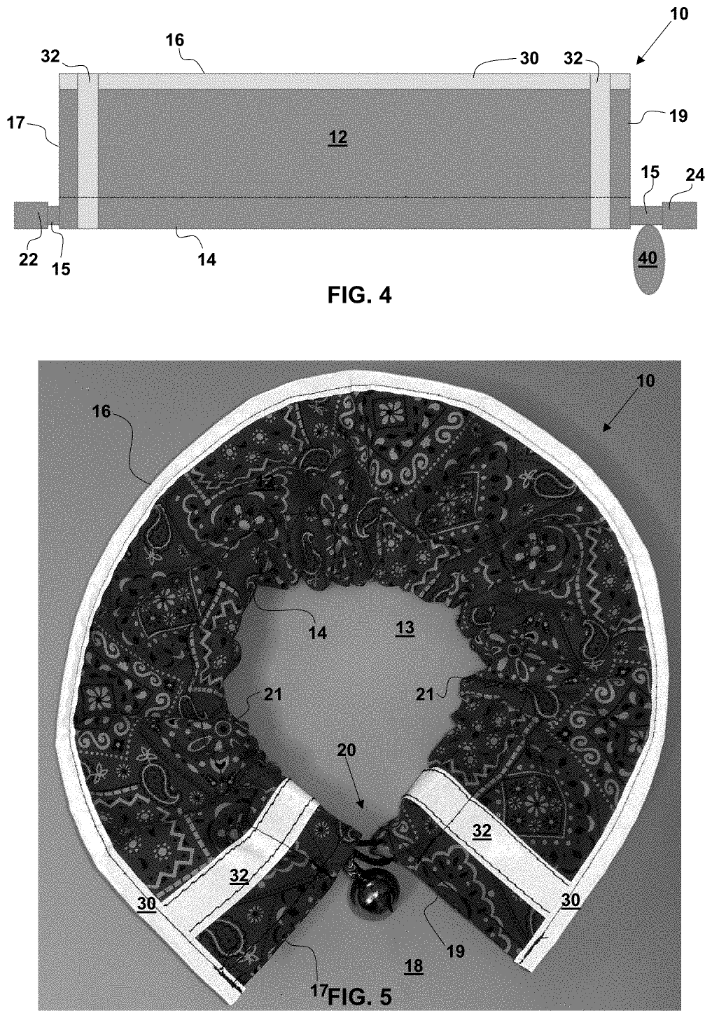

As shown in FIG. 4, when the clasp 20 is open and the brim 12 is laid flat, the collar 10 forms a rectangle. The height of the rectangle in FIG. 4 corresponds to the width of the brim 12, which is, for example, between approximately 2.5″ and 2.75″. The material of the brim 12 at the inside perimeter 14 is folded and sewn to form a sleeve that contains the ribbon 15. In this exemplary embodiment, the sleeve is approximately 1″ wide. The ribbon 15 has opposite ends, each respectively attached to one part 22, 24 of the clasp 20. In this exemplary embodiment, the ribbon 15 is approximately 0.25″ wide.

Another exemplary embodiment of the collar 10 has portions of the brim 12 covered with a reflector 30 that substantially reflects light. In an exemplary embodiment, the reflector 30 is a light-reflective tape, film, or material (e.g., plastic) disposed at least on a face-side 11 of the brim 12, the face-side 11 being the side of the brim 12 closer to the feline wearer's face (the opposing side of the brim 12 being a tail-side). Accordingly, when there is one or more light sources at an angle to the reflector 30 (e.g., of less than ninety (90) degrees), any prey that the feline is facing will receive light reflected from the reflector 30 and, thereby, be warned of the presence of the feline, even if the feline is crouching and partially hidden. In this exemplary embodiment of FIGS. 1 and 4, the outside perimeter has light-reflecting material 30 and the brim 12 has two stripes 32 of the same or different light-reflecting material 30 extending from the insider perimeter 14 to the outside perimeter 16. In the exemplary embodiments illustrated in the cloth configuration of FIG. 5 and in the diagram of FIG. 4, the reflective border 30 extends around the outside perimeter 16 and is approximately 0.25″ wide. The reflective stripes 32 are shown in the figures on both sides of the jaw when worn. These stripes 32 are approximately 0.5″ wide and are placed approximately 0.5″ from the respective edges 17, 19 of the cutout 19. The distance from the edges 17, 19 is sufficient to be visible to prey on either side of the feline's face.

As the brim 12 is a rectangle—and therefore reversible, each facing side of the brim 12 (the face side 11 and the opposite, not shown, tail side) can be of a similar material or a different one. Thus, the two sides can have similar visible features for prey or different ones. One side of the brim 12 can have the background color/colors/pattern and the shape of the light reflecting material in a first configuration, such as that shown in FIG. 5, and the other, opposite side can have a different color/colors/pattern and the light-reflecting material shape in a second configuration that is different from the first (for example, that shown in FIGS. 2 and 3 or in FIG. 4). The stripes 32 of light-reflecting material in the illustrated exemplary embodiments are shown as extending from the inside perimeter 14 to the outside perimeter 16. This configuration is merely exemplary and other configurations are equally possible. For example, one or both sides of the brim 12 can have stripes 32 at an angle, can have more than two stripes (even enough to encircle the internal area), and/or patterned or randomly positioned anywhere around the internal area 13.

While the exemplary embodiment of FIGS. 1 and 4 shows the brim 12 to be flat, another exemplary embodiment of the body of the collar 10 defining the brim 12 is a renaissance Elizabethan ruff collar neck ruffle, in which the body is three-dimensional and has a thickness orthogonal to the planar internal area 13 to define a cylindrical internal space that extends longitudinally along a neck of the when the collar 10 is worn by the feline. Such an embodiment is depicted in FIGS. 2, 3, and 5. In this embodiment of the collar 10, there is no ribbon 15. Instead, the fabric of the brim 12 at the inside perimeter 14 is folded and sewn to form a continuous sleeve 21 from the first edge 17 of the cutout 18 to the second edge 19 of the cutout 18. The size of the sleeve 21 is set to be sufficient to be able to thread a standard feline collar therethrough. Thus, for example, the width of the sleeve 21 for receiving the feline collar is approximately 1″. When threaded onto the feline collar and the feline collar is closed (e.g., the two lock parts of the clasp are buckled, touched together, or snapped in place), the feline collar and the collar 10 together form a disk around and projecting away from the cat's neck, which is shown in FIGS. 2, 3, and 5. The width of the sleeve 21 is selected to be sufficiently larger than the standard feline collar so that, when the feline collar is tightened and rotates to place the wide, inside, flat side of the feline collar around the neck, the sleeve 21 can accommodate that rotation without being caught in the feline collar and snagged to prevent smooth sliding of the feline collar within the sleeve 21.

In various exemplary embodiments, the brim 12 is of a material having a color that is more sensitive to the eye of feline prey, referred to herein as a bright fabric. For example, the color of the brim 12 can be white or yellow or orange or red or any combination thereof and/or a pattern with the color or color combinations. It is known that birds' eyes are most sensitive to the color white, because that color signals alarm and danger to birds. Similarly, a mammal's eye is most sensitive to a yellowish-green color, for example, a color having a wavelength curve peaking at 555 nanometers. Accordingly, a combination of white and yellow-green, either in a repeating pattern or a random pattern, is a configuration that is especially beneficial for distracting prey from felines.

Another exemplary embodiment of an audible warning device 40 shown as attached to the collar 10 is in the form of, for example, a sound generating bell 42. Such a sound generator 40 makes stalking cats audibly noticeable to any prey animal in any light condition, thereby giving the prey time to fly or run away to safety. In the embodiment of a bell 42, sound is generated by movement of the collar 10 caused by movement of the feline. Another exemplary embodiment of the audible warning device 40 can be a battery-powered tone generator 44, which can be removably attached to the brim 12 for periodically recharging or replacing a battery. The tone generator 44 can be any kind of buzzer or speaker that continually or periodically emanates an audible sound at a tone(s), a frequency(ies), a pattern(s), or a melody that alerts prey that the feline is present and where the feline is located. An electronic buzzer alarm sounder is one example of a removable audible warning device 40.

In use, the person places the collar 10 around the neck of the feline and closes the clasp 20 to secure the collar 10 on the feline. The brim 12 of the collar 10 projects away from the feline's skin in all directions, similar to a mane or the frill of the frill necked lizard, which is why the adjective Elizabethan for the collar 10 is appropriate. See, e.g., FIGS. 2 and 3. In any form of the collar 10 and brim 12, a reflector 30 (e.g., in the form of a light-reflective tape) is disposed about and adjacent the border of the brim 12, e.g., next to the outside perimeter 16. This and other reflective tape stripes 32 of the collar 10 enable the feline to be easily seen by prey in both bright and dim light conditions, from both above and below a cat, and visually alerts prey to the presence of the cat. In the embodiment where an audible warning device 40, in the form of a bell 42, is present, the bell 42 audibly alerts prey to the feline's presence when the feline moves.

To create the ribbon 15, the breakaway clasp 20 is threaded through a loop on the brim 12, on which is hung a loud bell 42. Either the brim 12 can be of a bright fabric or the bright fabric can be sewn onto the brim 12. The ribbon 15 is in the shape of a rectangle. The rectangle is folded lengthwise and sewn closed at the top with a border of reflective tape 30. Reflective stripes 32 of the tape are sewn to be positioned on both sides of the feline's jaw, making the cutout rest below the jaw of the feline. A row of stitches is sewn lengthwise along the fabric cover to create a flattened tube-shaped sleeve at the base of the fabric. The ribbon 15 with the breakaway clasp 20 and the loop containing the bell is slipped through the flattened tube-shaped sleeve, creating an Elizabethan-shaped, fabric-covered collar 10.

In another exemplary embodiment, the inside perimeter is sewn together to create a set of sleeve portions around the inside perimeter. These sleeve portions allow the standard feline's collar to be threaded therethrough to create an Elizabethan accessory to a standard feline neck collar. To install the accessory, the feline owner/user unfastens the clasp 20, slip the feline collar off of the feline, slips the feline collar through the sleeve/sleeves of the Elizabethan accessory, and adjusts the feline collar to fit the wearer's neck. If desired, a secondary clasp 20 can connect the edges 17, 19 of the cutout 18 so that the cutout 18 does not expand as the collar 10 is worn in this way.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the systems, apparatuses, and methods. However, the systems, apparatuses, and methods should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the systems, apparatuses, and methods as defined by the following claims.

What is claimed is:

1. A prey protection feline collar, comprising:
a collar body comprising a brim defining a planar internal area, an inside perimeter, an outside perimeter, a face side, and a cutout having edges, the inside and outside perimeters together defining a plane that projects substantially parallel to the planar internal area, the brim being configured to extend outward from a surface of a neck of a feline responsive to being worn;
a clasp removably connecting the edges to form a closure at the cutout;
a light reflector disposed at the face side of the brim and, responsive to receiving light, reflecting the light away from the face side; and
an audible warning device connected to the brim.

2. The collar according to claim 1, wherein the brim is substantially planar.

3. The collar according to claim 1, wherein the brim is in the form of a renaissance Elizabethan ruff collar neck ruffle.

4. The collar according to claim 1, wherein the brim comprises at least a portion having a prey-alerting color at the face side.

5. The collar according to claim 5, wherein the prey-alerting color is at least one of:
white;
yellow;
orange;
red;
yellow-green having a wavelength curve peaking at 555 nanometers;
a combination of any of the above colors;
a pattern of any of the above colors; and
a pattern of a combination of any of the above colors.

6. The collar according to claim 1, wherein the inside perimeter is sized to fit a household feline.

7. The collar according to claim 1, wherein the light reflector is a light-reflective tape one of attached to and integral with the brim.

8. The collar according to claim 1, wherein the light reflector comprises reflective strips adjacent each of the edges of the cutout.

9. The collar according to claim 1, wherein the audible warning device is at least one of a bell and an electronic tone generator.

10. The collar according to claim 1, wherein the collar body comprises a sleeve traversing the inside perimeter and defining therein a lumen; and further comprising a ribbon extending through the lumen around the inside perimeter and having opposing ribbon ends, the clasp comprising:
a first lock part connected to one of the ribbon ends; and
a second lock part connected to the other one of the ribbon ends, the first and second lock parts being removably connected to one another to form the closure at the cutout.

11. The collar according to claim 1, wherein the clasp has two portions that removably connect to one another.

12. The collar according to claim 11, wherein the two portions removably connect by at least one of:
hook-and-loops;
hook and eye;
lobster;
toggle;
spring;
torpedo;
box;
fishhook;
magnets;
buckle and holes; and
snap parts.

13. A prey protection feline collar, comprising:
a collar body comprising:
a brim defining a planar internal area, an inside perimeter, an outside perimeter, a face side, and a cutout having edges, the inside and outside perimeters together defining a plane that projects substantially parallel to the planar internal area, the brim being configured to extend outward from a surface of a neck of a feline responsive to being worn; and
a sleeve traversing the inside perimeter and defining therein a lumen;
a ribbon extending through the lumen around the inside perimeter and having opposing ribbon ends;
a clasp disposed in the cutout and comprising:
a first lock part connected to one of the ribbon ends; and
a second lock part connected to the other one of the ribbon ends, the first and second lock parts being removably connected to one another to form a closure at the cutout;
a light reflector disposed at the face side of the brim and, responsive to receiving light, reflecting the light away from the face side; and
an audible warning device connected to the brim.

14. The collar according to claim 13, wherein the brim is in the form of a renaissance Elizabethan ruff collar neck ruffle.

15. The collar according to claim 13, wherein the brim comprises at least a portion having a prey-alerting color at the face side, the prey-alerting color being at least one of:
white;
yellow;
orange;
red;
yellow-green having a wavelength curve peaking at 555 nanometers;
a combination of any of the above colors;
a pattern of any of the above colors; and
a pattern of a combination of any of the above colors.

16. The collar according to claim 13, wherein the inside perimeter is sized to fit a household feline.

17. The collar according to claim 13, wherein the light reflector is a light-reflective tape one of attached to and integral with the brim.

18. The collar according to claim 13, wherein the light reflector comprises reflective strips adjacent each of the edges of the cutout.

19. The collar according to claim 13, wherein the audible warning device is at least one of a bell and an electronic tone generator.

20. The collar according to claim 13, wherein:
the sleeve is a set of sleeve portions traversing the inside perimeter that, together, define therein a lumen; and
the ribbon extends through the lumen of the sleeve portions around the inside perimeter.
